(19) United States
(12) Patent Application Publication
(10) Pub. No.: US 2003/0043198 A1
(43) Pub. Date: Mar. 6, 2003

(54) Method and system for choosing an item out of a list appearing on a screen

(76) Inventor: Alain Delpuch, Les Essarts (FR)

Correspondence Address: Rory D. Rankin, Conley, Rose, & Tayon, P.C., P.O. Box 398, Austin, TX, 78767, US

(21) Appl. No.: 10/244,249

(22) Filed: Sep. 16, 2002

Related U.S. Application Data
(63) Continuation of application No. PCT/IB00/00351, filed on Mar. 17, 2000.

(51) Int. Cl. G09G 5/00

(52) U.S. Cl. 345/784

(57) ABSTRACT

The present invention concerns a system and a method of choosing an item by a user out of a long list (1) of items appearing on a screen (2) displaying said list, wherein the user scrolls through said list by moving a cursor along said list, said cursor designating a focused item and moving automatically from said focused item to a following one at an auto-repeat rate defining an auto-repeat period, if an action on a next item key by the user is maintained. The auto-repeat rate is periodically slowed down on predetermined items, termed sticky items, in order to give additional time to the user to absorb visual feedback on said sticky items.

The present invention relates to a method for choosing an item by a user out of a list of items appearing on a screen display, wherein the user scrolls through said list by moving a cursor along said list, the cursor designating a focused item and moving automatically from said focused item to a following one at an auto-repeat rate defining an auto-repeat period, if an action on a next item key is maintained by the user.

The invention also relates to a corresponding system.

In a computer or television environment, one problem is to let the user choose quickly or easily an item out of a very long list.

In the past pointing devices have been used, such as a mouse or keys on a remote control device.

In order to optimise the pointing, hierarchical properties have been developed with the list, such as organisation of the list as a tree.

Branches of the tree can be expanded or collapsed and navigation is achieved using the click button of a mouse or an arrow key of a keyboard.

However such systems have drawbacks.

Part of the trouble is coming from the fact that tree's structure, while very powerful, are also quite complex and not adapted to mass market.

Also, pointing devices like mice are not available in context like television or telephone, where commonly used pointing involve several function keys.

Furthermore, in the prior art, when an auto-repeat is provided, it happens at a constant rate, for instance comprised between 0.1 and 0.5 second.

Such time period is however either too short and does not bar from the risk of missing the searched item, or too long and renders the search fastidious.

To try to solve this problem, some user interfaces provide an acceleration of the auto-repeat rate with time.

However, the problem with such solution is to balance speeds and usability. When it starts going too fast the user cannot stop at the right item.

The present invention aims to solve these drawbacks and disadvantages.

For this purpose, it is an object of the present invention to provide a method and a system which render possible an acceleration of the user interface to select quickly an item among a large list of items, without risking to miss the searched item, and this without adding new keys or complex new concept, like tree's architecture.

It is another object of the present invention to provide easy navigation along a long list of items, allowing a quick selection while using the known and already existing remote devices, for instance remote devices used for selecting programs on a TV screen.

Another object of the invention is to provide a flat list of items to the viewer of a PC display screen, who is then authorised to select one item by using the arrow keys of a key board to navigate through the list, said list being for instance only displayed portion by portion, while an auto-repeat key is maintained pressed to move rapidly through the list.

It is another object of the invention to provide time saving and improved method and system for quick selection of items.

More precisely, the invention proposes a method of choosing an item by a user out of a long list of items appearing on a screen display, wherein the user scrolls through said list by moving a cursor along said list, said cursor designating a focused item and moving automatically from said focused item to a following one at an auto-repeat rate defining an auto-repeat period, if an action on a next item key is maintained by the user, characterised in that the auto-repeat rate is periodically slowed down on predetermined items, termed sticky items, in order to give additional time to the user to absorb visual feedback on said sticky items.

By focused item one should understand for instance an highlighted item.

Therefore one main feature of the invention resides in the control of the auto-repeat which periodically slows down on predetermined items and then speeds up while maintaining the next item key pressed continuously.

In other words, the idea is here to stop/pause the auto-repeat as it reaches relevant items of the list, termed the sticky items without releasing the action on the next item key.

This allows to move much faster than standard user interface, on less relevant items, i.e. five times to twenty times faster, i.e. for instance with an auto-repeat period as short as 0.01 s, and then to come back to a latency period of time of for instance 0.5 s on the relevant items. This greatly decreases the risk to over pass the searched item.

The present invention also proposes advantageous embodiments including one and/or a plurality of the following features:

when it is first focalised on an item with the cursor, said item is pointed out during a predetermined period of time, termed the latency period, different from the auto-repeat period.

In other words, when the cursor is moved to an item by pressing the next item key for the first time after a previous release, the latency period is experimented, then if pressure is maintained the auto-repeat period is implemented.

the cursor being moved by a next item key, the method comprises the steps of:

1—checking if said next item key is pressed by the user,

2—if next item key is pressed, arming a timer with the latency period,

3—focusing on next item,

4—checking if next item key is released,

5—if next item key is not released, checking if said timer has expired,

6—if said timer has expired, checking if the item is sticky,

7—if yes, arming the timer with a slow down period before focusing on the next item, and if not, arming the timer with the auto-repeat period before focusing on the next item, and

8—repeating steps 3 to 7, until next item key is released, an action key on the current or selected item being eventually pressed;

the auto-repeat rate is accelerating with time, before slowing down on sticky items;

the list is organised in a plurality of levels of items, comprising sticky items of first level, second level, . . . xth level, the slow down of the auto-repeat rate while reaching the relevant sticky items decreasing with the increase of the level in the list;

The first level is the most general one, appearing at first, for instance the country, then the more precise you become (department, town . . . ) the slower you are.

the auto-repeat period is comprised between 0.02 s and 0.1 s, and advantageously of the order of 0.05 s;

the latency period is comprised between 0.4 s and 1 s;

the auto-repeat rate is slowed down to of the order of 0.4 s to 0.6 s when reaching a sticky item.

The invention also provides a data processing system for choosing an item by a user out of a long list of items appearing on a screen display, wherein said system comprises

scrolling means for scrolling through said list including a cursor arranged to be moved along said list,

highlighting means for highlighting a focused item pointed by said cursor,

automatic moving means for automatically moving said cursor from said focused item to a following one at an auto-repeat rate defining an auto-repeat period, and

maintaining means for maintaining the scrolling by the user, characterised in that

it further includes slowing means for slowing down the auto-repeat rate periodically on predetermined items, termed sticky items, in order to give additional time to the user to absorb visual feedback on said sticky items.

By highlighting an item, one should here understand designating or pointing an item, and not obligatorily changing the colour or the contrast of its immediate environment with regard to the general background of the screen display.

Advantageously the system comprises highlighting means with timing means to highlight an item on which it is focalised for the first time with a cursor, during a predetermined period of time termed the latency period, different from the auto-repeat period.

In another advantageous embodiment the system comprises:

first checking means to check if said next item key is pressed by the user,

first timing means, arranged to arm a timer if next item key is pressed, with the latency period,

focusing means to focus on next item,

second checking means to check if next item key is released,

third checking means to check if said latency period has expired, if next item key is not released,

fourth checking means to check if the current item is sticky, if said latency period has expired,

second timing means arranged to arm a timer with a slow down period before focusing on the next item if said current item is sticky, and if not, arranged to arm the auto-repeat period before focusing on the next item,

and an action key to select the current focused item if decided.

By focusing means one should understand pointing means or highlighting means or equivalent.

Advantageously and more generally the system includes the needed means for providing the steps here above mentioned concerning the method.

The invention will be better understood from reading the following description of the particular embodiment given by way of non limiting example, and which refers to the accompanying drawings in which:

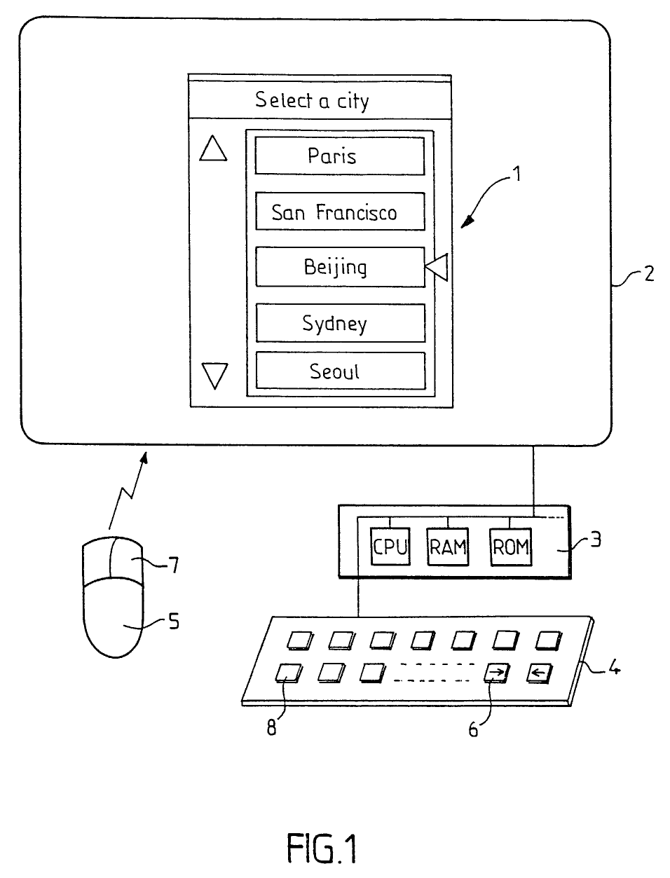

FIG. 1 shows a schematic diagram figuring a data processing system according to an embodiment of the invention, displaying a computer list.

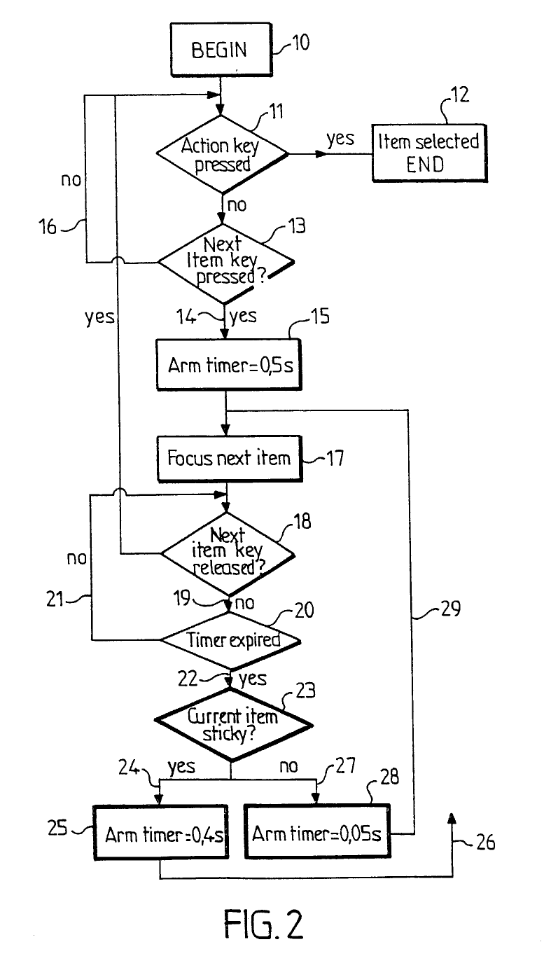

FIG. 2 shows a diagram featuring the main steps of an embodiment of the method according to the invention.

FIG. 1 shows a data processing system displaying a computer list 1.

The system comprises a screen display 2, connected to a computer 3 (for instance of the PC type) having a keyboard 4 and a mouse 5.

In this example the user has to select a city among one hundred, only five cities being displayed at a time.

The user has to scroll by pressing on a next item key 6 of the key board or on the click 7 of the mouse, through the all list, to find the city he or she wants to select. Then by double clicking or by using an action or selecting key 8 he or she enters the file of the searched item.

In the present example, the item is selected through criteria that matches user expectation, for example alphabetical order. Then auto-repeat to scroll according to the invention is provided.

In the prior art and typically, auto-repeat maximum rate is set around a tenth of a second to give the user time to analyse the visual feedback which renders fastidious searches among long list, a drawback avoided with the invention.

The list scanned according to the invention is of course not limited to the provided example. It could be for instance a list of TV channels grouped by themes. The program +/program-key of the remote control device is here used to change channel quickly, the auto-repeat slowing down as a new theme is reached.

Another example could be for instance with teletext pages numbered from 100 to 999.

Hundred generally group magazines (100s are generally news, 200s sport, 300s are entertainment, etc.).

Using the invention, a pair of key could be pressed to quickly increment/decrement page number, and pause longer as it reaches a new hundred range.

To implement the invention, the CPU and the ROM and RAM memories of the computer 3 or of the equivalent features in a TV set for instance, are programmed in a manner known per se by the man skilled in the art, in order to provide the steps of the method which is now described in reference to the diagram of FIG. 2.

The system being started in 10, a first test 11 checking if an action or selecting key 8 is pressed, is provided.

If yes, the item is selected in 12, and the search ends.

If not, the cursor being arranged to be moved by the user when pressing on a next item key, in the embodiment of the present invention more particularly described here, the method then comprises the steps of:

checking (test 13) if said next item key is pressed by the user,

if next item key is pressed (14), arming a timer with the latency period, for instance of 0.5 s (step 15),

if the next item key is not pressed (16) coming back to test 11,

focusing (step 17) on next item,

checking (step 18) if next item key is released,

if next item key is not released (line 19), checking in 20 if the current period provided by the timer has expired. The period could be the latency period, the auto-repeat period or the slowed down period on the sticky item,

otherwise coming back (line 21) to test 11,

if said period has expired (line 22), checking in 23 if the current item is sticky,

if yes (line 24), arming a timer in 25 with a slow down period (for instance 0.4 s) before going (line 26) for focusing on the next item (step 17), and

if not, arming in 28 the auto-repeat period before coming back (line 29) for focusing on the next item (step 17), and

repeating the relevant previous steps from step 17 to step 27, until next item key is released, an action key on the current focused item being then eventually pressed.

The functioning of the system will now be more particularly described taking the example of a list of city names sorted alphabetically on a computer screen display and in reference to FIG. 1.

Twenty six (A to Z) sticky items are retained, one for each letter of the alphabet.

After turning on the PC, the user will display the beginning of the list.

The screen display being not large enough to display the list entirely, such list will appear as a scrolling menu in a manner known per se, portion by portion.

The user will then point out with an arrow key on the name of a first item on the list then shall keep the next item key pressed with his finger.

The pointer goes very quickly from one letter to the other.

In the example involving a decreasing auto-repeat period down to 0.05 second, the auto-repeat allows therefore less than is to go from one letter to the other, where it is slowed down (each first city with a new initial being a sticky item).

More particularly, as the focus reaches a new letter, it slows down for example to 0.5 second, which gives the user time to absorb visual feedback.

Then when arrived to the right part of the list proposed he or she will proceed step by step to slowly reach the searched item, by pressing/depressing the next item key, therefore selecting each time the latency period for the timer (step 15), allowing him or her to do not overpass the relevant item which can then be entered by pressing the action key.

With the present invention, the stopping/pausing techniques allows to use accelerating auto-repeat period, the pausing period giving a time to the viewer to see or reach the selection.

Additional advantages and modifications will readily occur to those skilled in the art. Therefore the present invention in its broader aspects is not limited to the specific details, representative device and illustrated examples shown and described herein.

For instance, although the main usage will certainly be using two level lists, the invention can be generalised with n-level lists.

The idea would be here to pause when the selection moves one level up.

I.e. in a highly hierarchical set of items, like a large file system, huge database of cities, etc., sticky items will be provided at different levels, the higher the level, the biggest the slow down will be, as the sticky item is reached.

In the cases of world wide city database, the different levels could be continent, countries, states, regions, and then the cities themselves, sorted by alphabetical orders.

1. A method of choosing an item by a user out of a long list (1) of items appearing on a screen (2) displaying said list, wherein the user scrolls through said list by moving a cursor along said list, said cursor designating a focused item and moving automatically from said focused item to a following one at an auto-repeat rate defining an auto-repeat period, if an action on a next item key (6, 7) by the user is maintained, characterised in that the auto-repeat rate is periodically slowed down on predetermined items, termed sticky items, in order to give additional time to the user to absorb visual feed back on said sticky items, and each item is pointed out during a predetermined period of time, termed the latency period, different from the auto-repeat period.

2. A method according to claim 1, wherein the cursor is moved by a next item key (6,7), characterised in that said method comprises the steps of:
checking (13) if said next item key is pressed by the user,
if next item key is pressed, arming (15) a timer with the latency period,
focusing (17) on next item,
checking (18) if next item key is released,
if next item key is not released, checking (20) if said timer has expired,
if said timer has expired, checking (23) if the current item is sticky,
if yes, arming (25) the timer with a slow down period before focusing on the next item, and if not arming (28) the timer with the auto-repeat period before focusing on the next item, and
repeating steps 3 to 7, until next item key is released, an action key on the current focused item being eventually pressed (12).

3. A method according to claim 1,
characterised in that the auto-repeat rate is accelerating with time, before slowing down on sticky items.

4. A method according to claim 1,
characterised in that the list is organised in a plurality of levels of items, comprising sticky items of first level, second level, . . . xth level, the slow down of the auto-repeat rate while reaching the relevant sticky items decreasing with the increase of the level in the list.

5. A method according to claim 1,
characterised in that the auto-repeat period is comprised between 0.02 and 0.1 s.

6. A method according claim 1,
chracterised in that the latency period is comprised between 0.4 and 1 s.

7. A method according to claim 1,
characterised in that the auto-repeat rate is slowed down to of the order of 0.4 to 0.6 s.

8. An electronic data processing system for choosing an item by a user out of a long list (1) of items appearing on a screen (2) displaying said list, wherein said system comprises
scrolling means (3) for scrolling through said list including a cursor arranged to be moved along said list,
highlighting means for highlighting a focused item pointed by said cursor,
automatic moving means (3) for automatically moving said cursor from said focused item to a following one at an auto-repeat rate defining an auto-repeat period, and
maintaining means (6, 7, 3) for maintaining the scrolling by the user, characterised in that it further includes slowing means (3) for slowing down the auto-repeat rate periodically on predetermined items, termed sticky items, in order to give additional time to the user to absorb visual feedback on said sticky items, wherein in that said highlighting means comprises timing means to highlight any first item on which it is focalised with the cursor, during a predetermined period of time, termed the latency period, different from the auto-repeat period.

9. A system according to claim 8, characterised in that it comprises :
first checking means to check (13) if said next item key is pressed by the user,
first timing means arming (15) a timer if next item key is pressed, with the latency period,
focusing means to focus (17) on next item,
second checking means to check (18) if next item key is released,
third checking means to check (20) if said timer has expired, if next item key is not released, ,
fourth checking means to check (23) if the current item is sticky, if said timer has expired,
second timing means to arm (25) the timer with a slow down period before focusing on the next item if said current item is sticky, and if not arming (28) the timer with the auto-repeat period before focusing on the next item,
and an action key (8) to select the current focused item if decided.

10. A system according to claim 8,
characterised in that it comprises accelerating means to accelerate the auto-repeat rate with time, before slowing down on sticky items.

11. A system according to claim 8,
characterised in that it comprises a list having a plurality of levels of items, comprising sticky items of first level, second level, . . . xth level, and it comprises slowing means to slow down the auto-repeat rate while reaching the relevant sticky items said slowing down increasing with the level in the list.

12. A system according to claim 8,
characterised in that the auto-repeat period is comprised between 0.02 and 0.1 s.
